(19) United States
(12) Patent Application Publication
(10) Pub. No.: US 2026/0073738 A1
(43) Pub. Date: Mar. 12, 2026

(54) Vehicle Part Identification for Autonomous Driving Vehicles

(71) Applicants: Hyundai Motor Company, Seoul (KR); Kia Corporation, Seoul (KR)

(72) Inventor: Jongtae Kim, Hwaseong-SI (KR)

(21) Appl. No.: 19/230,899

(22) Filed: Jun. 6, 2025

(30) Foreign Application Priority Data
Sep. 9, 2024 (KR) 10-2024-0122429

(51) Int. Cl. G07C 5/00; B60K 35/10; B60K 35/28; G06Q 10/0875; G06Q 40/04

(52) U.S. Cl. CPC G07C 5/008; B60K 35/10; B60K 35/28; G06Q 10/0875; G06Q 40/04

(57) ABSTRACT

An apparatus for identifying a vehicle part and initiating installation of the vehicle part on a vehicle may comprise a database configured to store quantity information on a plurality of part names registered for a plurality of vehicle identification numbers, each corresponding to a respective vehicle type among a plurality of vehicle types, and a processor coupled to the database. The processor is configured to, during autonomous driving control of the vehicle, receive, from a first terminal associated with the vehicle, an indication signal indicating a vehicle identification number and a first part name of a first target part associated with a sensed state of a vehicle part, identify a corresponding vehicle type and vehicle identification number in the database, detect a matching part name, output a signal indicating the detected part name and associated quantity information, and transmit the signal to the first terminal for display.

### CROSS-REFERENCE TO RELATED APPLICATION

This application claims the benefit of priority to Korean Patent Application No. 10-2024-0122429 filed in the Korean Intellectual Property Office on Sep. 9, 2024, the entire contents of which are incorporated herein by reference.

### FIELD

The present disclosure relates to a technical solution for managing and identifying vehicle parts during autonomous driving, with focus on enhancing precision and reducing errors in part identification and installation by using vehicle part identification and management system of a vehicle.

### BACKGROUND

The matters described in this Background section are only for enhancement of understanding of the background of the disclosure, and should not be taken as acknowledgment that they correspond to prior art already known to those skilled in the art.

Online trading of used parts is one example of vehicle part management systems. A supplier of used parts, such as a vehicle recycling facility, may extract valuable or usable parts from a vehicle during vehicle dismantling processes and register or record the parts in a database for availability. Recorded parts may be searched and accessed through a system that provides part availability information. Users may identify and procure appropriate parts via the system.

The registration and search of used parts in the system may utilize vehicle-specific data, such as a vehicle identification number (VIN), vehicle type, or part information. However, inconsistencies in part information during registration, such as missing or incorrect part details, may hinder the identification of suitable parts. Such inconsistencies may affect part retrieval and matching processes.

### SUMMARY

According to the present disclosure, an apparatus for identifying a vehicle part and initiating installation of the vehicle part on a vehicle, the apparatus may comprise, a database configured to store quantity information on a plurality of part names registered for a plurality of vehicle identification numbers, wherein each of the plurality of vehicle identification numbers corresponds to a respective vehicle type among a plurality of vehicle types, and a processor coupled to the database, the processor configured to, during autonomous driving control of the vehicle, receive, from a first terminal associated with the vehicle, an indication signal indicating a vehicle identification number and a first part name of a first target part, wherein the reception of the indication signal is associated with a sensed state of a vehicle part of the vehicle, based on the received vehicle identification number, identify a corresponding vehicle type among the plurality of vehicle types in the database and identify a corresponding vehicle identification number among the plurality of vehicle identification numbers in the database, based on the identified vehicle type, detect a part name matching the first part name among a plurality of part names registered for the identified vehicle identification number, output a signal indicating the detected part name and quantity information associated with the detected part name, and during autonomous driving control of the vehicle, transmit the signal to the first terminal for display. The apparatus, wherein the processor is configured to, receive, from a second terminal, vehicle identification numbers, part names, and quantities for each of a plurality of parts to be registered, wherein each of the plurality of parts are represented by a respective one of the part names, based on each of the vehicle identification numbers, determine a plurality of option master folders in the database, wherein each of the plurality of option master folders corresponds to a respective one of the plurality of vehicle types in the database, and identify, among a plurality of lists of the determined option master folders, a list corresponding to the received vehicle identification number, and modify, based on the received quantities, a quantity of a part in the list, wherein the part corresponds to one of the received part names.

The apparatus, wherein the processor is configured to, identify the corresponding vehicle type among the plurality of vehicle types by combining a plurality of pieces of information of a plurality of digits in the received vehicle identification number, and determine, based on the identified vehicle type, an option master folder among the plurality of option master folders.

The apparatus, wherein the processor is configured to, identify the corresponding vehicle type among the plurality of vehicle types by combining a plurality of pieces of information of a plurality of digits in the received vehicle identification number, determine, based on the identified vehicle type, an option master folder, identify, based on the received vehicle identification number, a list among a plurality of lists of the determined option master folder, and search for a part name among a plurality of part names in the list, wherein the part name matches the first part name.

The apparatus, wherein the processor is configured to, generate a second list, wherein the second list may comprise the part name matching the first part name and a quantity of a part represented by the first part name among the plurality of part names of the list, and transmit the second list to the first terminal.

The apparatus, wherein the processor is configured to, receive, from the first terminal, a selection input for the second list, and based on the selection input, transmit a response request to the first terminal, wherein the response request is associated with the part name and a value associated with the part name.

The apparatus, based on a response to the response request being completed, the processor is configured to transmit, to the second terminal, a request to initiate data associated with part transfer, wherein the second terminal causes a transfer of the part for initiating installation of the part on the vehicle.

The apparatus, wherein the processor is configured to, receive, from a second terminal, the plurality of vehicle identification numbers, the plurality of part names, option information, and quantities for a plurality of parts to be registered, wherein each of the plurality of parts corresponds to a respective one of the plurality of part names, identify, based on the identified vehicle type, one of a plurality of option master folders, determine, based on the identified one of the plurality of option master folders, a list among a plurality of lists of the identified one of the plurality of option master folders, wherein the list corresponds to the received vehicle identification number, and based on the received quantities, modify a quantity of a part in the list and the option information in the list, wherein the part corresponds to one of the received plurality of part names.

The apparatus, wherein the processor is configured to, based on a presence of at least two options, associated with the received vehicle identification number, for the first part name, transmit, to a server, the received vehicle identification number and a request for option information on the first part name from other vehicle, wherein the other vehicle corresponds to the received vehicle identification number, receive, from the server, the option information on the first part name, and detect, based on matching the received option information against the at least two options for the first part name, the first target part and a quantity of the first target part for initiating installation of the first target part on the vehicle.

The apparatus, wherein the processor is configured to, identify the corresponding vehicle type among the plurality of vehicle types by combining a plurality of pieces of information of a plurality of digits in the received vehicle identification number, determine, based on the identified vehicle type, an option master folder, and identify, based on the received vehicle identification number, a list among a plurality of lists of the determined option master folder.

The apparatus, wherein the processor is configured to, receive, from the first terminal, a vehicle number and acquire, from a server and based on the received vehicle number, the vehicle identification number.

According to the present disclosure, a method performed by an apparatus for identifying a vehicle part and initiating installation of the vehicle part on a vehicle, the method may comprise, storing, into a database, quantity information on a plurality of part names for a plurality of vehicle identification numbers, wherein each of the plurality of vehicle identification numbers corresponds to a respective vehicle type among a plurality of vehicle types, wherein the quantity information, the plurality of part names, the plurality of vehicle identification numbers are received from a plurality of second terminals, during autonomous driving control of the vehicle, receiving, from a first terminal associated with the vehicle, an indication signal indicating a vehicle identification number and a first part name of a first target part, wherein the receiving the indication signal is associated with a sensed state of a vehicle part of the vehicle, detecting, based on the received vehicle identification number in the database, a part name matching the first part name, and based on finding a target part matching the first part name, generating a list comprising a quantity of the target part, outputting a signal indicating the list, and transmitting, during autonomous driving control of the vehicle, the signal to the first terminal for display.

The method, wherein the storing the quantity information may comprise, determining, based on one of the vehicle identification numbers and a corresponding vehicle type, one of a plurality of option master folders, identifying, based on the determined one of the plurality of option master folders, a list among a plurality of lists of the determined one of the plurality of option master folders, and modifying, based on the quantity information, a quantity of a part in the list, wherein the part corresponds to one of the plurality of part names.

The method, wherein the detecting the part name may comprise, combining a plurality of pieces of information of a plurality of digits in the received vehicle identification number to identify a corresponding vehicle type among the plurality of vehicle types, determining, based on the identified vehicle type, an option master folder, identifying, based on the received vehicle identification number, a list among a plurality of lists of the determined option master folder, and searching for a part name among a plurality of part names in the list, wherein the part name matches the first part name.

The method, further may comprise, based on a selection input being received from the first terminal, wherein the selection input is for the list, transmitting a response request to the first terminal, wherein the response request is associated with the first part name and a value associated with the first part name, and based on a response to the response request being completed, transmitting, to a second terminal, a request to initiate data associated with part transfer, wherein the second terminal causes a transfer of the first target part for initiating installation of the first target part on the vehicle.

The method, further may comprise, confirming a presence of at least two options, associated with the received vehicle identification number, for the first part name, transmitting, to a server, the received vehicle identification number and a request for option information on the first part name from other vehicle, wherein the other vehicle corresponds to the received vehicle identification number, receiving, from the server, the option information on the first part name, and detecting, based on matching the received option information against the at least two options for the first part name, the first target part and a quantity of the first target part for initiating installation of the first target part on the vehicle.

The method, further may comprise, receiving, from the first terminal, a vehicle number, and acquiring, from a server and based on the received vehicle number, the vehicle identification number.

A server may comprise, a communication circuit configured to, receive, from a plurality of second terminals and via a network, a registration request and information on vehicle parts, and receive, from at least one of a plurality of first terminals and via the network, a search request and information on target vehicle parts, a database configured to, based on the received information on the vehicle parts, store quantity information on a plurality of vehicle part names registered for a plurality of vehicle identification numbers, wherein each of the plurality of vehicle identification numbers corresponds to a respective vehicle type among a plurality of vehicle types, and a processor configured to, during autonomous driving control of a vehicle, receive, from a terminal associated with the vehicle via the communication circuit, an indication signal indicating a first vehicle identification number and a first part name of a first target vehicle part, wherein the reception of the indication signal is associated with a sensed state of a vehicle part of the vehicle, based on the first vehicle identification number, identify a corresponding vehicle type among the plurality of vehicle types in the database and identify a corresponding vehicle identification number among the plurality of vehicle identification numbers in the database, based on the identified vehicle type, detect a part name matching the first part name among a plurality of vehicle part names registered for the identified vehicle identification number, output a signal indicating the detected part name, and during autonomous driving control of the vehicle, transmit the signal to the terminal associated with the vehicle.

The server, wherein the received information on vehicle parts may comprise a vehicle identification number, a part name, and a quantity for each of the vehicle parts to be registered, and wherein the processor is further configured to, determine, based on each of the plurality of vehicle identification numbers, a plurality of option master folders in the database, wherein each of the plurality of option master folders corresponds to a respective one of the plurality of vehicle types in the database, and identify, among a plurality of lists of the determined plurality of option master folders, a list corresponding to the first vehicle identification number, and modify, based on the quantity information, a quantity of a vehicle part in the list, wherein the vehicle part corresponds to a vehicle part name in the received information.

The server, wherein the processor is configured to, identify the corresponding vehicle type among the plurality of vehicle types by combining a plurality of pieces of information of a plurality of digits in the first vehicle identification number, determine, based on the identified vehicle type, an option master folder, identify, based on the first vehicle identification number, a list among a plurality of lists of the determined option master folder, and search for a vehicle part name among a plurality of vehicle part names in the list, wherein the vehicle part name matches the first part name.

### BRIEF DESCRIPTION OF THE DRAWINGS

FIG. 1 shows an example of a vehicle part management system of a vehicle including a server according to an example.

FIG. 2 shows an example of a list of used parts by vehicle identification numbers built in a database of the server according to an example.

FIG. 3 shows an example of a method of registering used parts by the server according to an example.

FIG. 4 shows an example of an operation of a vehicle part management system of a vehicle according to an example.

FIG. 5 shows an example of the vehicle part management system of a vehicle according to an example.

FIG. 6 shows an example of a method of registering used parts having options by the server according to an example.

FIG. 7 shows an example of the operation of the vehicle part management system of a vehicle according to an example when a target part has options.

FIG. 8 shows an example of a portion of a database of the server according to some examples.

FIG. 9 shows an example of a configuration of an external server according to some examples.

FIG. 10 shows an example of the operation of the vehicle part management system of a vehicle that receives a vehicle number and a part name from a user terminal according to some examples.

### DETAILED DESCRIPTION

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

According to the present disclosure, a technical solution for identifying and managing vehicle parts during autonomous driving of a vehicle to ensure precision and reduce errors in part identification and installation is introduced. It includes a database storing part names, quantities, and associations with vehicle identification numbers (VINs), where each VIN corresponds to a specific vehicle type. A processor receives an indication signal during the autonomous driving, containing the VIN and a target part name linked to a sensed state of a vehicle part. Based on the VIN, the processor identifies the vehicle type, detects a matching part name from the database, confirms its availability, and generates a signal with the part name and quantity. This signal is transmitted to a terminal of the vehicle for display, enabling automated part identification and maintenance. By integrating these features in the autonomous driving, it reduces manual intervention errors and improves autonomous vehicle functionality through real-time, data-driven decisions.

The present disclosure relates to a vehicle part management system of a vehicle, which may search and find parts more accurately by registering used parts using a part name based on a vehicle identification number (VIN) instead of a conventional vehicle part number. Through this, online trading of used parts may be activated. When the VIN of a vehicle (hereinafter, applicable vehicle) to which a part (e.g., purchase target part) that a user wants to obtain is applied is the same as the VIN of a vehicle (hereinafter, the registered vehicle) corresponding to used parts (e.g., registered or recorded used parts) registered in an online database, the applicable vehicle and the registered vehicle will be substantially the same vehicle, and parts constituting each vehicle will also be the same. Under this condition, if a part name of the target part matches a part name of the registered used part, two parts may be the same part. That is, in vehicles having the same VIN, the part name and the part number may have a 1:1 correspondence, and the part name may replace the part number. A method of searching for used parts according to an example of the present disclosure and a server using the same may easily and accurately find the registered used parts corresponding to the target part by utilizing this point.

In the process of scrapping a vehicle, parts of a scrapped vehicle may be removed by each VIN and registered in a database of a server. In the following description, the “server” may register used parts, store information on the registered used parts, and search and provide information on target parts from the stored information.

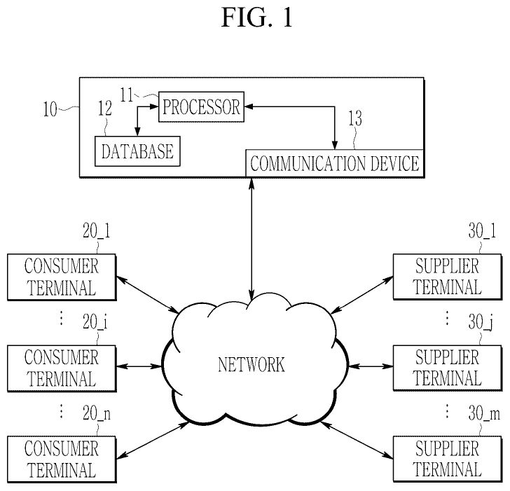

FIG. 1 shows an example of a used parts management system of a vehicle including a server according to an example.

As shown in FIG. 1, a vehicle part management system 1 of a vehicle may include a server 10, a plurality of user terminals (e.g., consumer terminals 20_1 to 20_n) connected to a server 10 through a network, and a plurality of terminals (e.g., supplier terminals 30_1 to 30_m). The plurality of terminals 30_1 to 30_m are terminals of a plurality of suppliers who wish to register the used parts in the server 10 and provide the registered used parts, and the plurality of user terminals 20_1 to 20_n are terminals of a plurality of users who wish to find target parts among the used parts registered in the server 10. In FIG. 1, ‘n’ and ‘m’ are natural numbers greater than or equal to 2, “20_i” represents one user terminal among the plurality of user terminals 20_1 to 20_n, and “30_j” represents one of the plurality of terminals 30_1 to 30_m, where ‘i’ is a natural number between 1 and n, and ‘j’ is a natural number between 1 and m.

The server 10 may provide and operate a site for trading used parts online through a network. Each of the plurality of terminals 30_1 to 30_m may access an online site and register used parts. Each of the plurality of user terminals 20_1 to 20_n may access an online site to search for target parts and obtain the registered used parts searched. Alternatively, each of the plurality of terminals 30_1 to 30_m may have a supplier application installed therein, and each of the plurality of user terminals 20_1 to 20_n may have a user application installed therein. Each of the plurality of suppliers may register used parts through each of the corresponding plurality of terminals 30_1 to 30_m, and each of the plurality of users may search for and obtain used parts matching the target parts through each of the corresponding plurality of user terminals 20_1 to 20_n.

The server 10 may include a processor 11, a database 12, and a communication device 13.

The communication device 13 may receive a registration request along with information on used parts from at least one of a plurality of terminals 30_1 to 30_m through the network. The communication device 13 may receive a search request along with information on target parts from at least one of the plurality of user terminals 20_1 to 20_n through the network. The communication device 13 may transmit the received information and request, etc., to the processor 11.

The processor 11 may classify the used parts received along with the registration request based on a VIN and a part name and store the classified used parts in the database 12 according to the registration request. The processor 11 may search for registered used parts having the same VIN and part name as the VIN and the part name of the target part according to the search request. The processor 11 may generate a list (e.g., a list of available parts) indicating the registered used parts and quantities that match the target parts if there are the registered used parts with the same VIN and part name in the database 12. The processor 11 may transmit the generated list to the corresponding user terminal 20_i through the communication device 13.

Regarding the registered used parts that match the target part or the registered used parts selected through the user terminal 20_i among the plurality of registered used parts listed in the list, the user may input a decision to obtain through the user terminal 20_i. The user terminal 20_i may transmit the input decision to the server 10, and the communication device 13 may receive the decision from the user terminal 20_i, and provide the decision to the processor 11. Then, the processor 11 may transmit a response request (e.g., the payment request along with an amount of value associated with used parts) to the user terminal 20_i. The user may perform the payment through the user terminal 20_i.

The processor 11 may transmit information indicating that payment for the amount for the registered used parts has been completed to the corresponding supplier terminal 30_j after the payment for the amount has been completed. After receiving the payment completion information through the corresponding supplier terminal 30j, the supplier may transport the registered used parts to a user's address.

After identifying the VIN of the scrapped vehicle, the supplier may transmit the part names of the used parts removed from the scrapped vehicle along with the VIN of the scrapped vehicle to the server 10 through the supplier terminal.

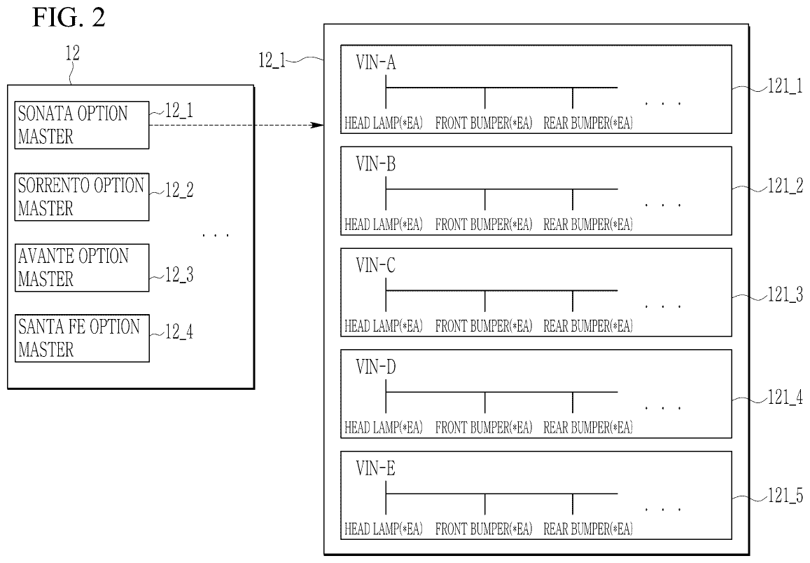

FIG. 2 shows an example of a list of used parts by VINs built in a database of the server according to an example.

The database 12 includes a plurality of option master folders 12_1, 12_2, 12_3, 12_4, . . . for a plurality of vehicle types. As shown in FIG. 2, the plurality of option master folders 12_1, 12_2, 12_3, 12_4, . . . are generated and structured in the database 12 for each of the plurality of vehicle types.

For example, each of the plurality of option master folders 12_1, 12_2, 12_3, and 12_4 is for “Sonata option master”, “Sorento option master”, “Avante option master”, and “Santa Fe option master”, respectively.

Each of the option master folders includes the plurality of lists for the plurality of VINs belonging to the corresponding vehicle type. In each of the plurality of lists, the part names of each of the plurality of used parts belonging to each VIN and the quantities for each of the plurality of used parts are matched and classified. For example, as shown in FIG. 2, the Sonata option master folder 12_1 may include lists 121_1, 121_2_, 121_3, 121_4, and 121_5, which are distinguished by five VINs, such as the plurality of VINs VIN-A, VIN-B, VIN-C, VIN-D, and VIN-E. The part names and quantities (*EA) of the plurality of used parts such as “headlamp”, “front bumper”, and “rear bumper” are matched and classified in each list 121_1, 121_2_, 121_3, 121_4, and 121_5 corresponding to each of the plurality of VINs VIN-A, VIN-B, VIN-C, VIN-D, and VIN-E.

The VIN is information that indicates a plurality of options such as country of manufacture, manufacturer, vehicle type, vehicle size, detailed vehicle type, vehicle body shape, presence or absence of safety devices, engine displacement, check box, year of manufacture, and production plant. The vehicle type may be information that distinguishes between passenger car, van, cargo truck, special vehicle, trailer, etc., the vehicle size may be information that distinguishes between mini car, small to mid-size car, small car, compact car, mid-size car, full-size car, large car, etc., the detailed vehicle type may be information that distinguishes between cargo, dump, mixer, basic specifications, premium specifications, high-end specifications, etc., and the vehicle body type may be information that distinguishes between limousine, 2-door to 5-door, coupe, wagon, pickup, etc., and the presence or absence of the safety devices may indicate presence or absence of manual seat belt, automatic seat belt, airbag, etc. The check box may indicate a gear ratio of an automatic transmission, 2-wheel/4-wheel information, etc.

Each option that makes up the VIN may be identified by at least one of alphabets and numbers, and each option of the VIN may be information in units of 1 byte. Information from first to eleventh digits of the VIN indicates the country of manufacture, manufacturer, vehicle type, vehicle size, detailed vehicle type, vehicle body shape, presence or absence of safety devices, engine displacement, check box, year of manufacture, and production plant, and each digit may be information in units of 1 byte. Therefore, information from 1 to 11 digits of the VIN may be information defining a category to which a vehicle belongs. 12 to 17 digits of the VIN are production serial numbers, which may be different for each vehicle. The plurality of VINs belonging to each of the plurality of folders may be continuously generated according to the change in each of the pieces of information included in the VIN.

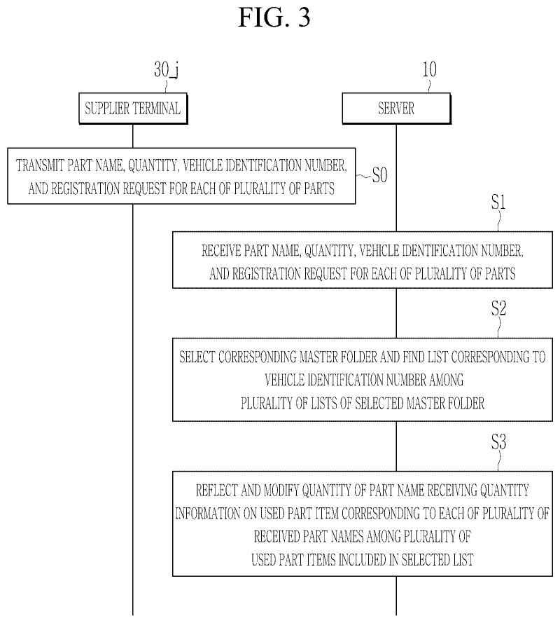

FIG. 3 shows an example of a method of registering used parts by the server according to an example.

First, the supplier may remove the plurality of parts from a scrapped vehicle and identify the part names of each of the plurality of removed parts and the VIN of the scrapped vehicle. The supplier may transmit the part names and VINs for each of the plurality of removed parts to the server 10 using a terminal (e.g., supplier terminal 30j). The supplier terminal 30_j may transmit the part names and quantities for each of the plurality of parts, the VIN of the scrapped vehicle, and the registration request for the parts to the server 10 (S0).

The server 10 may receive the part names and quantities of each of the plurality of parts removed from the scrapped vehicle, the VIN of the scrapped vehicle, and the registration request for the parts from the supplier terminal 30_j of the supplier (S1). The information received by the communication device 13 of the server 10 may be transmitted to the processor 11. The following steps S2 and S3 may be performed by the processor 11 of the server 10.

The processor 11 may select a corresponding option master folder among the plurality of option master folders 12_1, 12_2, 12_3, and 12_4 in the database 12 based on the received VIN, and may find a list corresponding to the VIN among the plurality of lists included in the selected option master folder (S2). If there is no option master folder corresponding to the VIN, the processor 11 may generate a new option master folder. In addition, if there is no list corresponding to the VIN in the selected option master folder, the processor 11 may generate a list corresponding to the VIN in the corresponding option master folder. The processor 11 may determine the vehicle type by combining pieces of information of a plurality of digits in the received VIN. For example, the processor 11 may determine the vehicle type by combining pieces of information of second (manufacturer), fourth (vehicle size), eighth (engine displacement), tenth (manufacturing year), and eleventh (production plant) digits in the VIN. The processor 11 may find the option master folder corresponding to the vehicle type.

The processor 11 may modify the quantity information on the used part items corresponding to each of the plurality of received part names among the plurality of used part items included in the selected list by reflecting the quantity of the received part name (S3). If there is no used part item corresponding to the received part name among the plurality of used part items included in the selected list, the processor 11 may generate the used part item in the selected list with the received part name.

The server 10 may store the quantity information on each of the plurality of registered used part names for each of the plurality of VINs for each of the plurality of vehicle types received from the plurality of terminals 30_1 to 30_m through steps S1 to S3 shown in FIG. 3 in the database 12, and manage the information stored in the database 12.

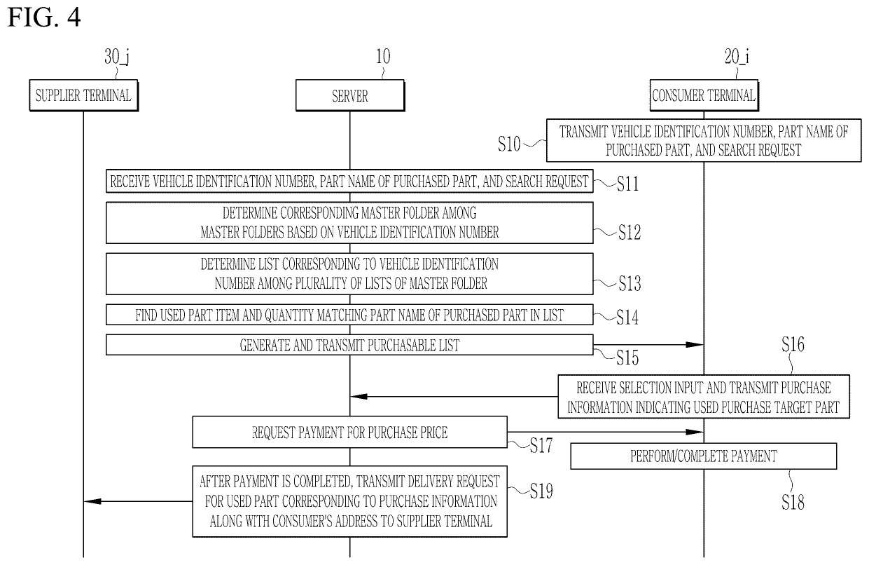

FIG. 4 shows an example of an operation of a used parts management system of a vehicle according to an example.

A user may transmit a search request to the server 10 along with the VIN and the part name of the target part through the user terminal 20_i (S10). Optionally, in step S10, the user may also transmit the quantity of the target part to the server 10 through the user terminal 20_i.

The server 10 may receive the search request along with the VIN and the name of the target part from the user terminal 20_i (S11). The server 10 may also receive the quantity of the target part.

The processor 11 may determine a corresponding option master folder among the plurality of option master folders 12_1, 12_2, 123, and 12_4 based on the VIN received from the user terminal 20_i (S12). If there is no option master folder corresponding to the VIN among the plurality of option master folders 12_1, 12_2, 12_3, and 124, the processor 11 may transmit a search failure to the user terminal 20_i through the communication device 13. The processor 11 may determine the vehicle type by combining pieces of information of second (manufacturer), fourth (vehicle size), eighth (engine displacement), tenth (manufacturing year), and eleventh (production plant) digits in the received VIN. The processor 11 may determine an option master folder corresponding to the determined vehicle type among plurality of option master folders 12_1, 12_2, 12_3, and 12_4.

The processor 11 may determine a list corresponding to the VIN among plurality of lists included in the option master folder determined in step S12 (S13). If there is no list corresponding to the VIN among the plurality of lists, the processor 11 may transmit the search failure to the user terminal 20_i through the communication device 13.

The processor 11 may find the used part item and quantity matching the part name of the target part in the list found in step S13 (S14). If there is no used part item matching the part name of the target part in the list or the quantity is ‘0’, the processor 11 may transmit the search failure to the user terminal 20_i through the communication device 13.

The processor 11 may generate a list including the used part item and quantity matching the part name of the target part and the quantity thereof found in step S14 and transmit the generated list to the user terminal 20_i (S15).

The user terminal 20_i may receive the list and provide the received list to the consumer. The user may select the used parts to be obtained from the received list. The user terminal 20_i may receive a selection input and transmit information indicating the used target parts to be obtained according to the received selection input to the server 10 (S16).

The server 10 may receive information from the user terminal 20_i and transmit a response request (e.g., a payment request for the price) to the user terminal 20_i (S17).

The user may perform the payment through the user terminal 20_i (S18). The user terminal may perform payment with an external payment server. The payment completion may be transmitted from the payment server to the server 10.

After the payment completion, the server 10 may receive the payment completion from the payment server and transmit a request to initiate data associated with part transfer along with the user's address to the supplier terminal 30j of the supplier who has registered the used parts corresponding to the received information (S19). The supplier may confirm the payment completion through the supplier terminal 30j. The supplier may transfer the obtained used parts to the user's address received through the supplier terminal 30_j.

The examples may register and search for the used parts based on the VIN. However, the present disclosure is not limited thereto, and the vehicle part management system of a vehicle may use an external server including the database matching the vehicle number and the VIN.

An example of the external server may be a server (e.g., an insurance company server) operated by an insurance company. The “insurance company server” is a server of an insurance company that provides insurance services for vehicles, and may store and manage data on the VIN corresponding to the vehicle number. For example, when the server 10 receives a vehicle number from the user terminal 20_i, it may request information on the VIN corresponding to the vehicle number from all insurance company servers. The server 10 may receive the VIN from the server of the insurance company to which the vehicle of the corresponding vehicle number is subscribed among all insurance company servers. In the following description, the “insurance company server” means a server of the insurance company to which the vehicle is subscribed.

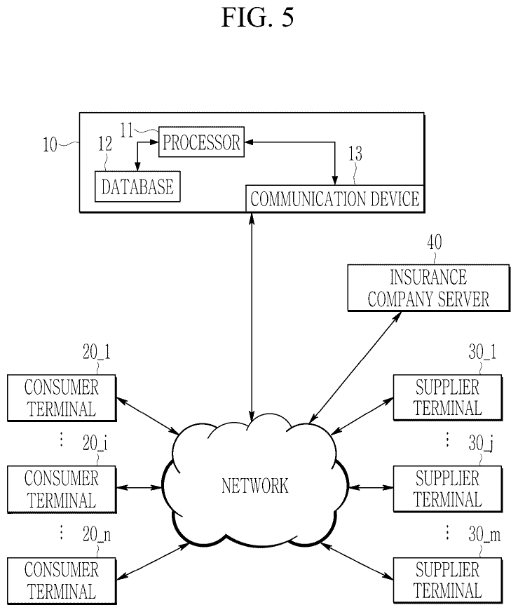

FIG. 5 shows an example of the used parts management system of a vehicle according to an example.

A vehicle part management system 2 of a vehicle may further include the components 10, 20_1 to 20_2, and 30_1 to 30_m of the example of FIG. 1 and an external server (e.g., an insurance company server) 40. The same reference numerals are used in FIG. 5 for the same components as in the example of FIG. 1. The same description as in the example of FIG. 1 may be omitted below.

A user may input a part name of a target part along with the VIN or vehicle number to the user terminal 20_i. When the server 10 receives the vehicle number from the user terminal 20_i, the server 10 may request the VIN corresponding to the vehicle number from the insurance company server 40. The insurance company server 40 may receive the vehicle number and search for the VIN corresponding to the vehicle number in response to the request and transmit the searched VIN to the server 10. The server 10 may receive the VIN corresponding to the vehicle number, and may search for a matching registered used part among the registered used parts based on the received VIN and the part name received from the user terminal 20_i.

The insurance company server 40 may include information on components installed in the vehicle according to the selection options among the components installed in the vehicle. For example, the driver's seat may have two options: electric type and manual type. The electric type is a method in which the height, front and back of the driver's seat, and an inclination of a backrest are adjusted by an electric motor or hydraulic pressure. The manual type is a method in which the height, front and back of the driver's seat, and the inclination of the backrest are adjusted by the driver's operation of a mechanical device such as a lever. The insurance company server 40 may store information on whether the driver's seat installed in the vehicle of the vehicle number is the electric or manual type by matching the information to the vehicle number. It is difficult for a user to accurately remember information (hereinafter, “option information”) about all options for components installed in his or her vehicle. However, when signing up for vehicle insurance, the user may transmit option information on various components installed in the vehicle to the insurance company server 40 through the user terminal 20_i, etc. The insurance company server 40 may match the vehicle number, the VIN, the option information, etc., to the insurance subscriber and store and manage them in the database. When the target part to be installed in the vehicle by the user includes two or more options, it may be difficult for the user to specify the exact part name. To solve this, the server 10 may request the option information on the corresponding part installed in the user's vehicle from the insurance company server 40 if the received target part includes two or more options.

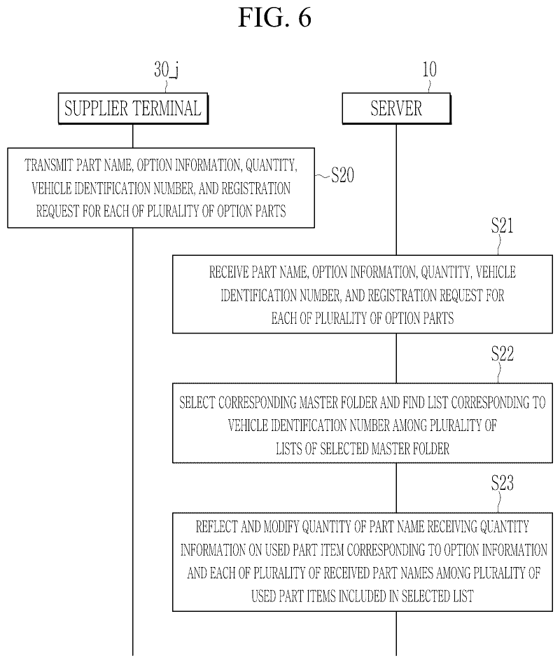

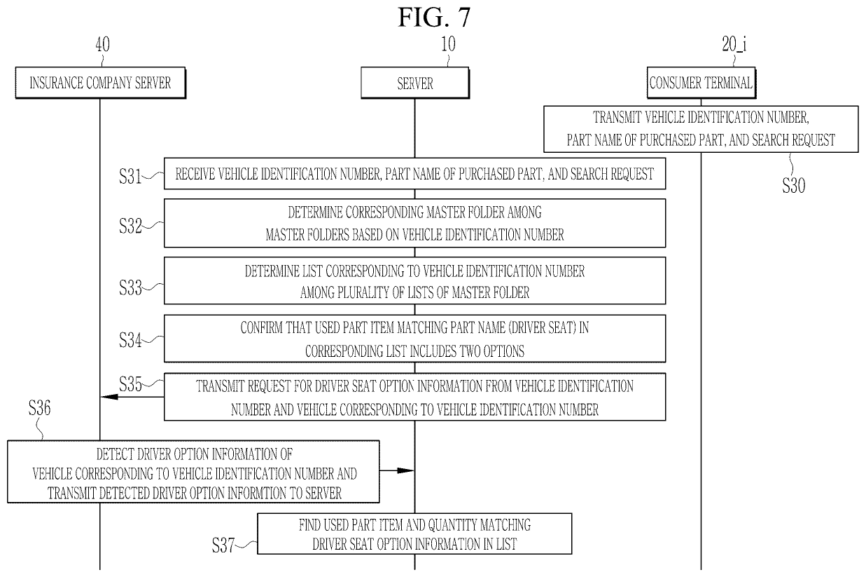

FIGS. 6 and 7 are flowcharts for describing the operation of the vehicle part management system of a vehicle shown in FIG. 5.

FIG. 6 shows an example of a method of registering used parts having options by the server according to an example.

First, the supplier may remove a plurality of parts from a scrapped vehicle, and identify the part name and option information of each of the plurality of parts (hereinafter referred to as option parts) having options among the plurality of removed parts, and the VIN of the scrapped vehicle. The supplier may transmit the part name and option information on each of the plurality of removed option parts along with the VIN to the server 10 using a terminal (e.g., supplier terminal 30_j). The supplier terminal 30_j may transmit the part names, option information, and quantities of each of the plurality of option parts, the VIN of the scrapped vehicle, and the registration request for these parts to the server 10 (S20).

The server 10 may receive the part names, option information and quantities of each of the plurality of option parts removed from the scrapped vehicle, the VIN of the scrapped vehicle, and the registration request for the parts from the supplier terminal 30_j of the supplier (S21). The information received by the communication device 13 of the server 10 may be transmitted to the processor 11. The following steps S2 and S3 may be performed by the processor 11 of the server 10.

The processor 11 may select a corresponding option master folder among the plurality of option master folders 12_1, 12_2, 12_3, and 12_4 in the database 12 based on the received VIN, and may find a list corresponding to the VIN among the plurality of lists included in the selected option master folder (S22). If there is no option master folder corresponding to the VIN, the processor 11 may generate a new option master folder. In addition, if there is no list corresponding to the VIN in the selected option master folder, the processor 11 may generate a list corresponding to the VIN in the corresponding option master folder. The processor 11 may determine the vehicle type by combining pieces of information of a plurality of digits in the received VIN. For example, the processor 11 may determine the vehicle type by combining pieces of information of second (manufacturer), fourth (vehicle size), eighth (displacement), tenth (manufacturing year), and eleventh (production plant) digits in the VIN. The processor 11 may find the option master folder corresponding to the vehicle type.

The processor 11 may modify the quantity information on the used part items corresponding to each of the plurality of received part names and the option information among the plurality of used part items included in the selected list by reflecting the quantity of the received part name (S3). If there is no used part item corresponding to the received part name among the plurality of used part items included in the selected list, the processor 11 may generate the used part item in the selected list with the received part name and option information.

FIG. 7 shows an example of the operation of the vehicle part management system of a vehicle according to an example when a target part has options.

For the convenience of description the example referring to FIG. 7, the target part is described as the ‘driver's seat’. The driver's seat may include two options: electric type and manual type. The option information may be information indicating the electric or manual type.

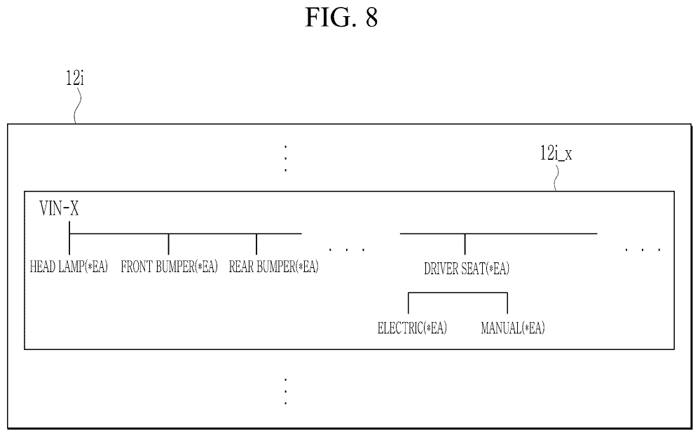

FIG. 8 shows an example of a portion of a database of the server according to an example.

First, the user terminal 20_i transmits a VIN VIN-X of the vehicle and the part name (driver's seat) of the target part to the server 10, and a search request (S30).

The server 10 may receive the VIN VIN-X of the vehicle and the part name (driver's seat) of the target part, and the search request (S31).

The processor 11 of the server 10 may determine the corresponding option master folder 12_i among the plurality of master option folders based on the VIN VIN-X in the database 12, as shown in FIG. 8 (S32).

The processor 11 of the server 10 may determine a list 12i_x corresponding to the VIN VIN-X among the plurality of lists of the corresponding option master folder 12_i as shown in FIG. 8 (S33).

The processor 11 confirms that the used part item matching the part name (driver's seat) in the list 12i_x includes two options (electric and manual types) (S34).

The server 10 may transmit a request for the VIN and driver's seat option information from the vehicle corresponding to the VIN to the insurance company server 40 to select one of the two options (S35).

The insurance company server 40 may detect the driver's seat option information of the vehicle corresponding to the VIN and transmit the detected driver's seat option information to the server 10 (S36).

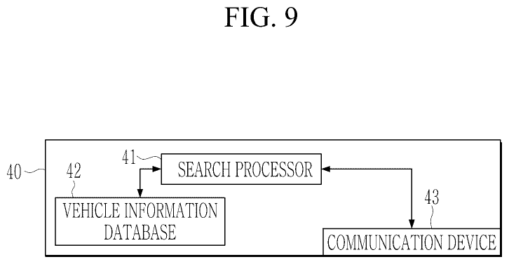

FIG. 9 shows an example of a configuration of an external server according to some examples.

The insurance company server 40 may include a communication device 13, a search processor 41, and a vehicle information database 42.

The vehicle information database 42 may include vehicle numbers, VINs, and option information on each of a plurality of vehicles subscribed to the insurance.

The communication device 43 may receive a request for the VIN and option information from the server 10 through the network, and transmit the request for the VIN and option information to the search processor 41.

The search processor 41 may search for the driver seat option information among the option information of the vehicle corresponding to the VIN in the vehicle information database 42. The search processor 41 may transmit the searched driver seat option information to the communication device 43 along with the transmission command. The communication device 43 may transmit the driver seat option information to the server 10 according to the transmission command.

The server 10 may receive the driver seat option information, and accordingly, may find the used part item and quantity matching the driver seat option information in the list 12i_x (S37). The subsequent progress steps may be identical to steps S15 to S19 of FIG. 4.

Although the flow chart of FIG. 7 describes that the user inputs the VIN and the part name of the target part to the vehicle part management system of a vehicle, the disclosure is not limited thereto. Since the insurance company server stores the information on the vehicle number and the VIN, when the vehicle part management system of a vehicle uses the insurance company server, the vehicle number may be input instead of the VIN.

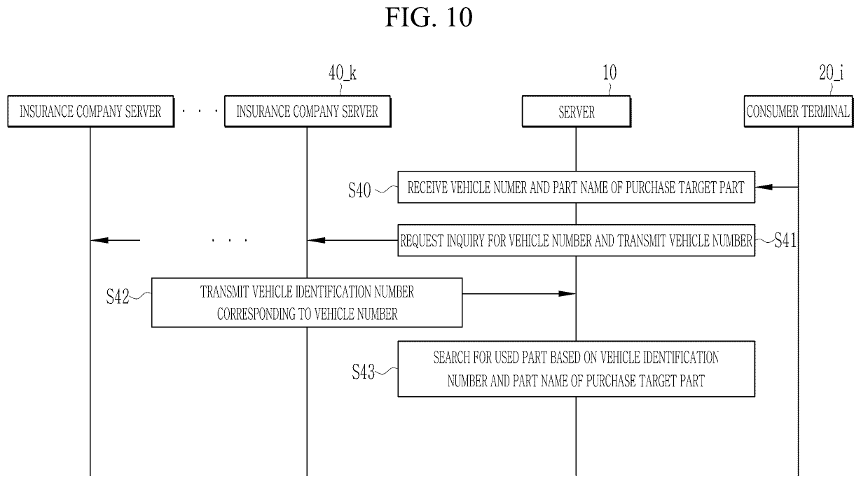

FIG. 10 shows an example of the operation of the used parts management system of a vehicle that receives a vehicle number and a part name from a user terminal according to some examples.

The server 10 may receive the vehicle number and the part name of the target part from the user terminal 20_i (S40). The processor 11 may receive the vehicle number and the part name of the target part from the communication device 13. The processor 11 recognizes that there is no information that matches the VIN format and may recognize the vehicle number instead of the VIN.

The server 10 may transmit a vehicle number inquiry request to all insurance company servers along with the vehicle number in order to acquire the VIN corresponding to the vehicle number. For example, the processor 11 may command the communication device 13 to transmit the vehicle number inquiry request to the insurance company servers along with the vehicle number. All insurance companies mean all insurance companies that provide insurance services for vehicles. The communication device 13 may transmit the vehicle number and the inquiry request to the insurance company servers according to the command (S41).

Among the insurance company servers, an insurance company server 40_k (k is an arbitrary natural number) of the insurance company that provides insurance service for the vehicle with the received vehicle number may transmit the VIN corresponding to the vehicle number to the server 10 (S42).

The communication device 13 of the server 10 receives the VIN corresponding to the vehicle number and provides the received VIN to the processor 11, and the processor 11 may search for used parts based on the VIN and the part name of the target part (S43). Steps after step S43 may include steps of the above-described examples, for example, steps S12 to S19 or steps S32 to S37.

The present disclosure attempts to provide an online trading method capable of activating online trading of used parts and an online trading server implementing the method.

According to an example of the present disclosure, a vehicle part management system of a vehicle includes a database that stores quantity information on each of a plurality of used part names registered for each of a plurality of vehicle identification numbers for each of a plurality of vehicle types, a processor that receives a vehicle identification number and a first part name of a first target part from a user terminal, determines a corresponding vehicle type among the plurality of vehicle types and a corresponding vehicle identification number among the plurality of vehicle identification numbers of the corresponding vehicle type based on the vehicle identification number in the database, and finds a part name identical to the first part name among the plurality of used part names registered for the determined vehicle identification number.

The processor may receive, from a supplier terminal, vehicle identification numbers, part names, and quantities for each of the plurality of used parts to be registered, determine one of a plurality of option master folders corresponding to the plurality of vehicle types included in the database based on each vehicle identification number and determine a list corresponding to the vehicle identification number among a plurality of lists of the determined option master folders, and modify a quantity of used part item matching the received part name in the corresponding list according to the received quantity.

The processor may determine the corresponding vehicle type among the plurality of vehicle types by combining a plurality of pieces of information of the plurality of digits among each vehicle identification number, and determine an option master folder corresponding to the determined vehicle type among the plurality of option master folders.

The processor may determine the corresponding vehicle type among the plurality of vehicle types by combining the plurality of pieces of information of the plurality of digits among the received vehicle identification number, determine the option master folder corresponding to the determined vehicle type, determine a list corresponding to the vehicle identification number among the plurality of lists of the determined option master folder, and search for a used part item identical to the first part name among the plurality of used part items of the list.

The processor may generate a list including the used part item identical to the first part name and the quantity of used part item identical to the first part name among the plurality of used part items of the list, and transmit the list to the user terminal.

When a selection input for the list is received from the user terminal, a payment request for a purchase price for the registered used part corresponding to the received selection input in the used part item identical to the first part name may be transmitted to the user terminal.

When payment is completed in response to the payment request, a delivery request may be transmitted to the supplier terminal that supplies the registered used part corresponding to the received selection input.

The processor may receive, from a supplier terminal, vehicle identification numbers, part names, option information, and quantities for each of the plurality of used parts to be registered, determine one of a plurality of option master folders corresponding to the plurality of vehicle types included in the database based on each vehicle identification number and determine a list corresponding to the vehicle identification number among a plurality of lists of the determined option master folders, and modify a quantity of used part item matching the received part name and the option information in the corresponding list according to the received quantity.

When it is confirmed that the used part item identical to the first part name among the plurality of used part items of the list corresponding to the determined vehicle identification number includes at least two options, the processor may transmit the vehicle identification number and a request for option information on the first part name from the vehicle corresponding to the vehicle identification number to an external server, receive option information on the first part name from the insurance company server, and find a used part item and quantity matching the received option information among the at least two options of the used part item identical to the first part name.

The processor may determine the corresponding vehicle type among the plurality of vehicle types by combining a plurality of pieces of information of the plurality of digits of the received vehicle identification number, determine an option master folder corresponding to the determined vehicle type, and determine a list having a vehicle identification number identical to the vehicle identification number among the plurality of lists of the determined option master folders.

When receiving a vehicle number instead of the vehicle identification number from the user terminal, the processor may acquire the vehicle identification number from the insurance company server to which a vehicle of the vehicle number is subscribed.

According to another example of the present disclosure, a used part trading method of a vehicle performed by a server includes storing quantity information on each of a plurality of used part names of each of a plurality of vehicle identification numbers for each of a plurality of vehicle types received from a plurality of terminals in a database, receiving the vehicle identification number and the first part name of the first target part from the user terminal, and finding a part name identical to the first part name based on the vehicle identification number in the database, and when a target part identical to the first part name is found, generating a list including a quantity of the target part and transmitting the generated list to the user terminal.

The storing of the quantity information on each of the plurality of used part names in the database may include determining one of the plurality of option master folders corresponding to the plurality of vehicle types included in the database based on each of the vehicle identification numbers, determining a list corresponding to the vehicle identification number among the plurality of lists of the determined option master folders, and modifying a quantity of used part item matching the received part name in the corresponding list according to the received quantity.

The finding of the part name identical to the first part name may include combining a plurality of pieces of information of the plurality of digits of the received vehicle identification number to determine the corresponding vehicle type among the plurality of vehicle types, determining an option master folder corresponding to the determined vehicle type, and determining a list corresponding to the vehicle identification number among a plurality of lists of the determined option master folders, and searching for a used part item identical to the first part name among the plurality of used part items of the list.

The used part trading method of a vehicle may further include when a selection input for the list is received from the user terminal, transmitting a payment request for a purchase price for the registered used part corresponding to the received selection input in the used part item identical to the first part name to the user terminal, and when payment is completed in response to the payment request, transmitting a delivery request to the supplier terminal that supplies the registered used part corresponding to the received selection input.

The used part trading method of a vehicle may further include confirming in the database that a used part item identical to the first part name among the plurality of used part items of the list corresponding to the determined vehicle identification number includes at least two options, transmitting a request for option information on the vehicle identification number and the first part name from the vehicle corresponding to the vehicle identification number to an external server, and receiving option information on the first part name from the insurance company server, and finding a used part item and quantity matching the received option information among the at least two options of the used part item identical to the first part name.

The used part trading method of a vehicle may further include when receiving a vehicle number instead of the vehicle identification number from the user terminal, acquiring the vehicle identification number from the insurance company server to which a vehicle of the vehicle number is subscribed.

According to an example of the present disclosure, it is possible to activate the online trading of the used parts through the online trading of used parts using the vehicle identification number.

Although examples of the present disclosure have been described in detail hereinabove, the scope of the present disclosure is not limited thereto, but may include several modifications and alterations made by those skilled in the art using a basic concept of the present disclosure as defined in the claims.

What is claimed is:

1. An apparatus for identifying a vehicle part and initiating installation of the vehicle part on a vehicle, the apparatus comprising:
a database configured to store quantity information on a plurality of part names registered for a plurality of vehicle identification numbers, wherein each of the plurality of vehicle identification numbers corresponds to a respective vehicle type among a plurality of vehicle types; and
a processor coupled to the database, the processor configured to:
during autonomous driving control of the vehicle, receive, from a first terminal associated with the vehicle, an indication signal indicating a vehicle identification number and a first part name of a first target part, wherein the reception of the indication signal is associated with a sensed state of a vehicle part of the vehicle;
based on the received vehicle identification number, identify a corresponding vehicle type among the plurality of vehicle types in the database and identify a corresponding vehicle identification number among the plurality of vehicle identification numbers in the database;
based on the identified vehicle type, detect a part name matching the first part name among a plurality of part names registered for the identified vehicle identification number;
output a signal indicating the detected part name and quantity information associated with the detected part name; and
during autonomous driving control of the vehicle, transmit the signal to the first terminal for display.

2. The apparatus of claim 1, wherein the processor is configured to:
receive, from a second terminal, vehicle identification numbers, part names, and quantities for each of a plurality of parts to be registered, wherein each of the plurality of parts are represented by a respective one of the part names;
based on each of the vehicle identification numbers, determine a plurality of option master folders in the database, wherein each of the plurality of option master folders corresponds to a respective one of the plurality of vehicle types in the database, and identify, among a plurality of lists of the determined option master folders, a list corresponding to the received vehicle identification number; and
modify, based on the received quantities, a quantity of a part in the list, wherein the part corresponds to one of the received part names.

3. The apparatus of claim 2, wherein the processor is configured to:
identify the corresponding vehicle type among the plurality of vehicle types by combining a plurality of pieces of information of a plurality of digits in the received vehicle identification number; and
determine, based on the identified vehicle type, an option master folder among the plurality of option master folders.

4. The apparatus of claim 1, wherein the processor is configured to:
identify the corresponding vehicle type among the plurality of vehicle types by combining a plurality of pieces of information of a plurality of digits in the received vehicle identification number,
determine, based on the identified vehicle type, an option master folder;
identify, based on the received vehicle identification number, a list among a plurality of lists of the determined option master folder; and
search for a part name among a plurality of part names in the list, wherein the part name matches the first part name.

5. The apparatus of claim 4, wherein the processor is configured to:
generate a second list, wherein the second list comprises the part name matching the first part name and a quantity of a part represented by the first part name among the plurality of part names of the list, and
transmit the second list to the first terminal.

6. The apparatus of claim 5, wherein the processor is configured to:
receive, from the first terminal, a selection input for the second list; and
based on the selection input, transmit a response request to the first terminal, wherein the response request is associated with the part name and a value associated with the part name.

7. The apparatus of claim 6, based on a response to the response request being completed,
the processor is configured to transmit, to the second terminal, a request to initiate data associated with part transfer, wherein the second terminal causes a transfer of the part for initiating installation of the part on the vehicle.

8. The apparatus of claim 1, wherein the processor is configured to:
receive, from a second terminal, the plurality of vehicle identification numbers, the plurality of part names, option information, and quantities for a plurality of parts to be registered, wherein each of the plurality of parts corresponds to a respective one of the plurality of part names;
identify, based on the identified vehicle type, one of a plurality of option master folders;
determine, based on the identified one of the plurality of option master folders, a list among a plurality of lists of the identified one of the plurality of option master folders, wherein the list corresponds to the received vehicle identification number; and
based on the received quantities, modify a quantity of a part in the list and the option information in the list, wherein the part corresponds to one of the received plurality of part names.

9. The apparatus of claim 1, wherein the processor is configured to:
based on a presence of at least two options, associated with the received vehicle identification number, for the first part name,
transmit, to a server, the received vehicle identification number and a request for option information on the first part name from other vehicle, wherein the other vehicle corresponds to the received vehicle identification number;
receive, from the server, the option information on the first part name; and
detect, based on matching the received option information against the at least two options for the first part name, the first target part and a quantity of the first target part for initiating installation of the first target part on the vehicle.

10. The apparatus of claim 9, wherein the processor is configured to:
identify the corresponding vehicle type among the plurality of vehicle types by combining a plurality of pieces of information of a plurality of digits in the received vehicle identification number;
determine, based on the identified vehicle type, an option master folder; and
identify, based on the received vehicle identification number, a list among a plurality of lists of the determined option master folder.

11. The apparatus of claim 1, wherein the processor is configured to:
receive, from the first terminal, a vehicle number and
acquire, from a server and based on the received vehicle number, the vehicle identification number.

12. A method performed by an apparatus for identifying a vehicle part and initiating installation of the vehicle part on a vehicle, the method comprising:
storing, into a database, quantity information on a plurality of part names for a plurality of vehicle identification numbers, wherein each of the plurality of vehicle identification numbers corresponds to a respective vehicle type among a plurality of vehicle types, wherein the quantity information, the plurality of part names, the plurality of vehicle identification numbers are received from a plurality of second terminals;
during autonomous driving control of the vehicle, receiving, from a first terminal associated with the vehicle, an indication signal indicating a vehicle identification number and a first part name of a first target part, wherein the receiving the indication signal is associated with a sensed state of a vehicle part of the vehicle;
detecting, based on the received vehicle identification number in the database, a part name matching the first part name; and
based on finding a target part matching the first part name, generating a list comprising a quantity of the target part, outputting a signal indicating the list, and transmitting, during autonomous driving control of the vehicle, the signal to the first terminal for display.

13. The method of claim 12, wherein the storing the quantity information comprises:
determining, based on one of the vehicle identification numbers and a corresponding vehicle type, one of a plurality of option master folders;
identifying, based on the determined one of the plurality of option master folders, a list among a plurality of lists of the determined one of the plurality of option master folders; and
modifying, based on the quantity information, a quantity of a part in the list, wherein the part corresponds to one of the plurality of part names.

14. The method of claim 12, wherein the detecting the part name comprises:
combining a plurality of pieces of information of a plurality of digits in the received vehicle identification number to identify a corresponding vehicle type among the plurality of vehicle types;
determining, based on the identified vehicle type, an option master folder;
identifying, based on the received vehicle identification number, a list among a plurality of lists of the determined option master folder; and
searching for a part name among a plurality of part names in the list, wherein the part name matches the first part name.

15. The method of claim 12, further comprising:
based on a selection input being received from the first terminal, wherein the selection input is for the list, transmitting a response request to the first terminal, wherein the response request is associated with the first part name and a value associated with the first part name; and
based on a response to the response request being completed, transmitting, to a second terminal, a request to initiate data associated with part transfer, wherein the second terminal causes a transfer of the first target part for initiating installation of the first target part on the vehicle.

16. The method of claim 12, further comprising:
confirming a presence of at least two options, associated with the received vehicle identification number, for the first part name;
transmitting, to a server, the received vehicle identification number and a request for option information on the first part name from other vehicle, wherein the other vehicle corresponds to the received vehicle identification number;
receiving, from the server, the option information on the first part name; and
detecting, based on matching the received option information against the at least two options for the first part name, the first target part and a quantity of the first target part for initiating installation of the first target part on the vehicle.

17. The method of claim 12, further comprising:
receiving, from the first terminal, a vehicle number; and
acquiring, from a server and based on the received vehicle number, the vehicle identification number.

18. A server comprising:
a communication circuit configured to:
receive, from a plurality of second terminals and via a network, a registration request and information on vehicle parts; and
receive, from at least one of a plurality of first terminals and via the network, a search request and information on target vehicle parts;
a database configured to, based on the received information on the vehicle parts, store quantity information on a plurality of vehicle part names registered for a plurality of vehicle identification numbers, wherein each of the plurality of vehicle identification numbers corresponds to a respective vehicle type among a plurality of vehicle types; and
a processor configured to:
during autonomous driving control of a vehicle, receive, from a terminal associated with the vehicle via the communication circuit, an indication signal indicating a first vehicle identification number and a first part name of a first target vehicle part, wherein the reception of the indication signal is associated with a sensed state of a vehicle part of the vehicle;
based on the first vehicle identification number, identify a corresponding vehicle type among the plurality of vehicle types in the database and identify a corresponding vehicle identification number among the plurality of vehicle identification numbers in the database;
based on the identified vehicle type, detect a part name matching the first part name among a plurality of vehicle part names registered for the identified vehicle identification number;
output a signal indicating the detected part name; and
during autonomous driving control of the vehicle, transmit the signal to the terminal associated with the vehicle.

19. The server of claim 18, wherein the received information on vehicle parts comprises a vehicle identification number, a part name, and a quantity for each of the vehicle parts to be registered, and
wherein the processor is further configured to:
determine, based on each of the plurality of vehicle identification numbers, a plurality of option master folders in the database, wherein each of the plurality of option master folders corresponds to a respective one of the plurality of vehicle types in the database, and identify, among a plurality of lists of the determined plurality of option master folders, a list corresponding to the first vehicle identification number; and
modify, based on the quantity information, a quantity of a vehicle part in the list, wherein the vehicle part corresponds to a vehicle part name in the received information.

20. The server of claim 18, wherein the processor is configured to:
identify the corresponding vehicle type among the plurality of vehicle types by combining a plurality of pieces of information of a plurality of digits in the first vehicle identification number;
determine, based on the identified vehicle type, an option master folder;
identify, based on the first vehicle identification number, a list among a plurality of lists of the determined option master folder; and
search for a vehicle part name among a plurality of vehicle part names in the list, wherein the vehicle part name matches the first part name.
